(19) United States
(12) Patent Application Publication
(10) Pub. No.: US 2005/0044408 A1
(43) Pub. Date: Feb. 24, 2005

(54) Low pin count docking architecture for a trusted platform

(76) Inventors: Sundeep M. Bajikar, Santa Clara, CA (US); David I. Poisner, Folsom, CA (US); Leslie E. Cline, Sunnyvale, CA (US); Edwin J. Pole II, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/643,678

(22) Filed: Aug. 18, 2003

(51) Int. Cl. H04L 9/00

(52) U.S. Cl. 713/201

(57) ABSTRACT

A docking architecture for a notebook computer is described. Specifically, a circuit coupled to a Low Pin Count (LPC) bus monitors the LPC bus for trusted data cycles. If a trusted data cycle is detected, the circuit prevents the trusted data cycle from being available to a non-trusted component.

### FIELD OF THE INVENTION

The present invention pertains to the field of integrated circuit design. More particularly, the present invention relates to an architecture that protects secure data on a low pin count bus from a component external to the computer system.

### BACKGROUND OF THE INVENTION

LaGrande Technology (LT) is a security initiative by Intel Corp. to make computing safer and more secure. LT is built into both the processor and chipset to help increase the level of protection within the platform. LT provides an environment in which applications can run within their own protected space out of the view of other software.

### BRIEF DESCRIPTION OF THE DRAWINGS

FIG. 1 is an embodiment of computer architecture to provide a secure docking station; and

FIG. 2 is a flowchart for a secure docking station filtering mechanism.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Theft of data is a problem that affects computer systems. While data encryption may protect data transmitted over the Internet or through phone lines, data encryption does not offer much security against covertly embedded applications or components used by hackers to gain access to data being processed on a personal computer prior to encryption. For example, hackers can steal secrets by using a program for snooping platform keys, keystrokes, and passwords. Components can modify secrets by pretending to be a trusted device and responding to special cycles intended for a trusted component on a bus.

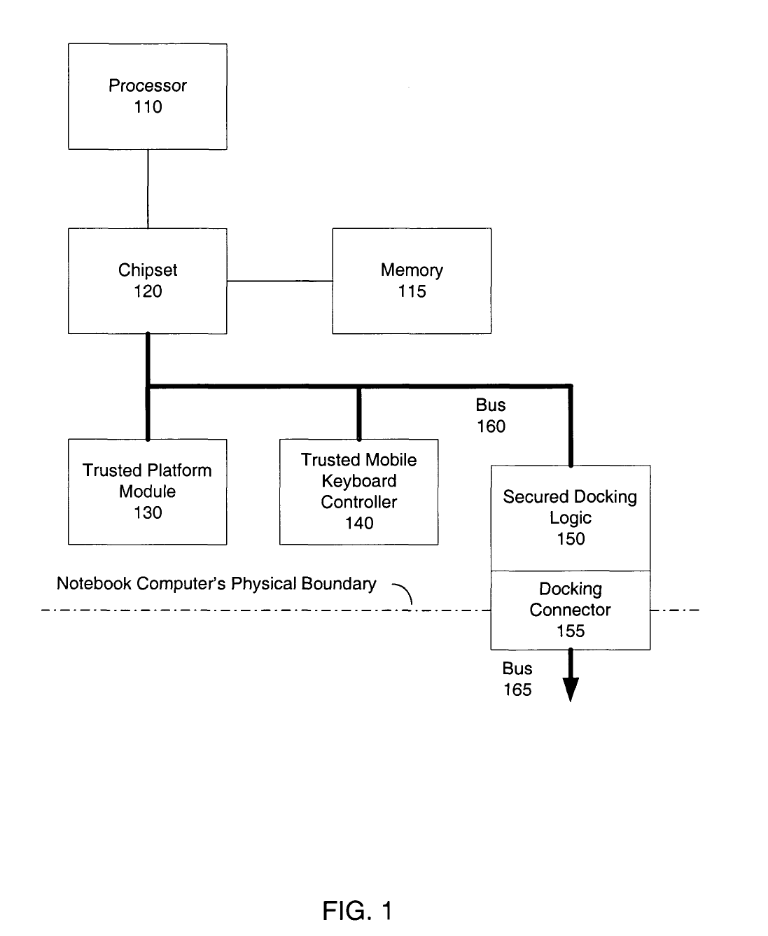

The docking interface or expansion slot of a notebook computer is one potential gateway that a hacker may use to gain access to the data of a computer system. A docking interface is typically used to connect periphery devices such as keyboards, mice, and speakers to a computer system. FIG. 1 depicts one embodiment of a computer architecture that protects against hacker attacks through the docking station.

The computer architecture of FIG. 1 comprises a processor 110 coupled to a chipset 120. Chipset 120 is coupled to a memory 115, a Trusted Platform Module (TPM) 130, a Trusted Mobile Keyboard Controller (TMKBC) 140, and a secured docking logic 150. The secured docking logic 150 is coupled to a docking connector 155.

The chipset 120 may deliver data to and from the processor 110, memory 115, and other devices external to the computer. External devices may be coupled to the chipset 120 via a docking connector 155 and bus 165. In a notebook computer designed for LT, the chipset 120 may also communicate with slave components such as the TPM 130 and the TMKBC 140. The TPM 130 and TMKBC 140 are attached directly to the motherboard of the computer system. The chipset 120 may be coupled to the TPM 130 and the TMKBC 140 via bus 160. For one embodiment of the invention, the bus 160 may be a Low Pin Count (LPC) bus. A LPC bus offers lower power consumption, less pins, and more robust design than a X-bus, which was designed to replace the traditional serial bus. The LPC bus allows legacy input/output (I/O) motherboard components, typically integrated in a Super I/O chip, to migrate from the Industry Standard Architecture bus or X-bus to the LPC interface, while retaining full software compatibility. Components such as the TPM 130 and the TMKBC 140 may be soldered to the motherboard. Thus, the LPC bus 160 has no connectors or headers available for plugging in other parts.

For another embodiment of the invention, the bus 160 may be a Peripheral Component Interconnect (PCI) bus. A PCI bus comprises connectors to allow for components to be plugged into the computer system.

The bus 165 may be a Universal Serial Bus (USB), a PCI bus, or a LPC bus.

The TPM 130 is a secure micro-controller component that provides hardware cryptographic functionalities. For example, the TPM 130 may provide (a) hardware protected storage, (b) platform binding, and (c) platform authentication. Hardware protected storage protects the user's secret data through a dedicated piece of hardware on the computer system. A user's secret data may include file encryption keys, VPN keys, and authentication keys. Hardware protection is accomplished by encrypting the secret data with the TPM 130. The secret data can then only be decrypted by the dedicated piece of hardware, which contains the necessary private key to decrypt the secret data. Hardware and software agents outside of the TPM 130 do not have access to the execution of the cryptographic functions within the TPM 130 hardware.

Platform binding is the process of logically binding critical data to the platform on which the data may be used. Data that is bound to a particular platform is only accessible by that platform if the conditions specified in the binding are met. If this data migrates to a different platform or if the specific binding conditions on the same platform are not met, the data cannot be accessed. Hardware and/or software configuration information about the platform may be used to implement the logical binding of critical information.

While binding secret data to the platform, the TPM 130 may merge the data together with platform configuration values. The combination is then encrypted. When the secret data needs to be accessed, the values of the necessary platform configurations are calculated from the encrypted combination. The secret data is released for use only if the calculated platform configuration matches the stored platform configuration.

The TPM 130 may also be used for platform authentication, or attestation. For instance, the computer system may send an identification request to a trusted third party (TTP). The TTP may be an IC chip. The TTP provides attestation to the platform's identification and configuration if the TTP recognizes certificates provided in the identification request. The TTP signs the identification request and returns the results to the TPM 130.

In contrast to the TPM 130, which provides cryptographic functionalities, the TMKBC 140 provides trusted input capabilities. For example, the TMKBC 140 may help enable the user's keyboard strokes and mouse clicks to be delivered to the computer system's operating system without modification or snooping. The operating system is responsible for verifying that the input is coming from a trusted keyboard or mouse. The channel between the operating system and the keyboard/mouse must be such that there is no other hardware or software mechanism to the channel.

The TMKBC 140 may provide a trusted interface and support a traditional untrusted interface. The trusted interface allows the chipset 120 to communicate with the TMKBC 140 in a trusted manner for obtaining information from the keyboard or mouse. The TMKBC 140 may provide keystroke data as standard USB Human Interface Device (HID) packets to either the trusted interface or to the untrusted interface. Trusted keystroke data is supplied directly only to protected memory and trusted applications. Similarly, the TMKBC 140 may provide pointer data from the mouse to the new interface or to the untrusted interface. Registers associated with the trusted interface may be mapped into trusted register space.

A data cycle that begins with a value of “0101” may indicate that the data being communicated from the chipset 120 to the TPM 130 or the TMKBC 140 is a trusted data cycle. The data cycle, however, may begin with any predefined trusted data cycle indicator. The trusted data cycle indicator allows the chipset 120 to communicate data in plaintext format with both the TPM 130 and the TMKBC 140 without using any form of encryption. On the other hand, if any other component on the bus 160 is able to decode the trusted cycles intended for the TPM 130 or TMKBC 140, then the uninvited component could pose a potential security threat to the trusted platform. For example, a component coupled to the bus 160 through the docking connector 155 and the bus 165 could make the bus 160 and all the data cycles of the bus available external to the notebook computer's physical boundaries.

The secured docking logic 150 may protect the communication between the chipset 120 and other components coupled to the bus 160. The secured docking logic 150 may be a circuit that provides a filtering mechanism. The secured docking logic 150 may detect trusted data cycles and then block them from appearing on the bus 165. This would prevent the trusted data cycles on the bus 160 from being exposed to any external devices that are coupled to the docking connector 155. The filtering mechanism may be implemented in hardware or software.

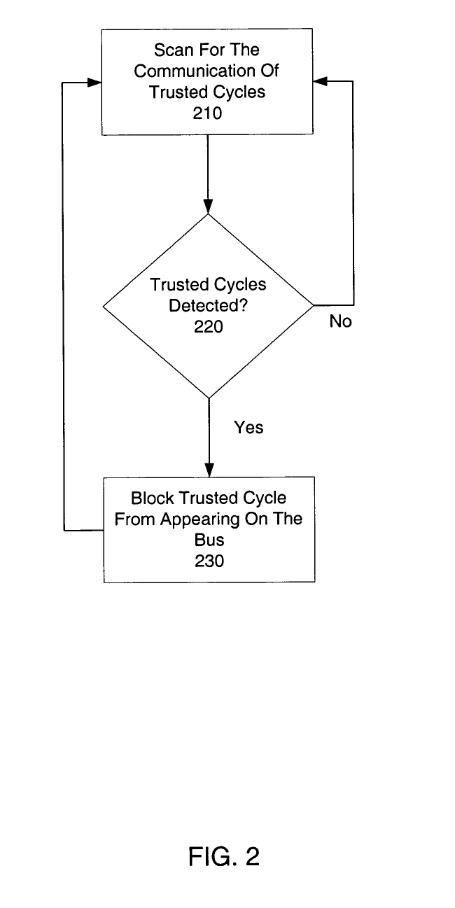

FIG. 2 depicts a flowchart for implementing the filtering mechanism of the secured docking logic 150. In operation 210, the secured docking logic 150 scans for trusted data cycles. For this embodiment of the invention, the trusted data cycle is identified by a data cycle that begins with a “0101” value. Operation 220 determines whether a trusted data cycle has been detected. If a trusted data cycle has been detected, then the filtering mechanism in operation 230 stops the trusted data cycle on the bus 160 from being exposed to any devices connected to the bus 165 for that data cycle. Otherwise, if a trusted data cycle is not detected, the secured docking logic 150 continues to scan for trusted data cycles.

In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

1. A computer system, comprising:
a chipset;
a bus coupled to the chipset to communicate a trusted data cycle to an internal component of the computer system; and
a circuit coupled to the bus that prevents a device external to the computer system from accessing the trusted data cycle.

2. The computer system of claim 1, wherein the bus is a Low Pin Count bus.

3. The computer system of claim 1, wherein the component provides protected memory storage.

4. The computer system of claim 1, wherein the component provides platform authentication.

5. The computer system of claim 1, wherein the component maintains a protected path between the chipset and a keyboard.

6. The computer system of claim 1, wherein the computer system is a notebook computer.

7. A circuit, comprising:
means for transmitting data on a Low Pin Count (LPC) bus; and
means for preventing trusted data cycles on the Low Pin Count (LPC) bus from being accessed by an unauthorized component.

8. The circuit of claim 7, further comprising:
means for connecting an external device to a notebook computer.

9. The circuit of claim 7, further comprising:
means for monitoring data cycles on the LPC bus.

10. A method, comprising:
monitoring a chipset of a computer system for communication of trusted data cycles on a bus; and
preventing the trusted data cycles from being available to a component external to the computer system.

11. The method of claim 10, wherein trusted data cycles begin with a “0101” value.

12. The method of claim 10, further comprising:
communicating trusted data cycles between the chipset and a first component.

13. The method of claim 12, wherein the communication between the chipset and the first component is in plaintext format.

14. The method of claim 10, further comprising:
communicating trusted data cycles between the chipset and a second component.

15. The method of claim 14, wherein the communication between the chipset and the second component is in plaintext format.

16. The method of claim 15, wherein the second component maintains a protected path between the chipset and a keyboard, wherein keystroke data is communicated by the chipset to protected memory and trusted applications.

17. The method of claim 15, wherein the second component maintains a protected path between the chipset and a mouse, wherein pointer data from the mouse is communicated by the chipset to protected memory and trusted applications.

18. The method of claim 12, wherein the first component protects secret data of the computer system by encrypting the secret data.

19. The method of claim 18, wherein the secret data is decrypted by hardware of the computer system.

20. The method of claim 18, wherein the first component merges data with the computer system's configuration values.

21. The method of claim 18, wherein the first component requests for a system identification request.

22. The method of claim 21, wherein a trusted third party chip verifies the computer system's identification and sends a response to the first component.
